(19) United States
(12) Patent Application Publication
(10) Pub. No.: US 2005/0061729 A1
(43) Pub. Date: Mar. 24, 2005

(54) Filter module and process for the production of a filled filter module

(75) Inventors: Gerhard Strohm, Dexheim (DE); Georg Schnieder, Bad Kreuznach (DE)

Correspondence Address: LEYDIG VOIT & MAYER, LTD, 700 THIRTEENTH ST. NW, SUITE 300, WASHINGTON, DC, 20005-3960, US

(73) Assignee: Pall Corporation, East Hills, NY (US)

(21) Appl. No.: 10/953,067

(22) Filed: Sep. 30, 2004

Related U.S. Application Data
(63) Continuation of application No. PCT/EP03/04101, filed on Apr. 17, 2003.

(30) Foreign Application Priority Data
Apr. 18, 2002 (DE) 102 17 262.5

(51) Int. Cl. B01D 24/00

(52) U.S. Cl. 210/284

(57) ABSTRACT

A filter module comprising filtering layers composed of a filter medium is described, in which layers of first and second draining spacing elements alternate and the draining spacing elements show, in an alternating sequence with respect to the filtrate chambers and the non-filtrate chambers throughflow elements on one side and sealing elements on the other side. In order to improve filtration and to make it possible to fulfil additional aims with reference to filtration and treatment of the fluid, whilst retaining a solid construction, the filter module is equipped with third spacing elements. Between two filtering layers, which are disposed between a first and second spacing element, there is disposed at least one such third spacing element which has sealing elements adjacent the filtrate chamber and the non-filtrate chamber. A process for the production of a filter module that is at least partially filled with treating material is also described.

This is a continuation application of pending international application No. PCT/EP03/04101 filed Apr. 17, 2003, which is incorporated herein by reference in its entirety and for all purposes.

### BACKGROUND OF THE INVENTION

The invention relates to a filter module containing filtering layers composed of a filtering medium, in particular containing filtering layers comprising beds of filtering material, said filtering layers being arranged alternatingly with layers of first and second draining spacing elements, the draining spacing elements each having, in alternating sequence with respect to the filtrate chamber and the non-filtrate chamber, a throughflow element on one side and a sealing element on the other side, wherein the spacing elements are designed to sealingly contact and squeeze the filtering layers. The invention also relates to a filter device comprising a housing accommodating such a filter module and a process for the production of a filter module that is at least partially filled with treating material.

The afore-mentioned filter modules are known in diverse constructions, the majority of these filter modules having in common that the filtering layers are made of flat materials, such as filter boards, papers, nonwovens, or fabrics.

Layers of filtering material usually consist of deep-bed filtering material exhibiting organic and/or inorganic, fibrous and/or granular materials. The basic materials used for layers of filtering material are usually cellulose or plastics fibers, in which, for example, kieselguhr, pearlites or metal oxides, or other activated filtering substances can be embedded. Kieselguhr and pearlites serve here to enlarge the internal surface area and thus to increase the sediment absorbing capacity.

The fields of application of layers of filtering material extend from the clarification and treatment of liquids within the entire beverage industry to applications in the pharmaceutical and chemical industries. Layers of filtering material not only have a screening effect, by means of which coarse particles are retained on the surface of the layer of filtering material, but also exhibit, in particular, a depth action for fine particles, which are caught in the cavities within the deep-bed filtering material. Depending on the type of materials used, these layers of filtering material can also have an adsorptive effect, and for certain applications the surface can be aftertreated to ensure that no fibrous particles can become detached in the dry or wet state.

DE 100 29 960 A1 discloses a filter module which has filtering layers of a filter medium, particularly filtering layers comprising filter beds, in which the filtering layers alternate with layers comprising draining spacing elements. There are provided first and second spacing elements, which have, in alternating sequence with respect to the filtrate chamber and the non-filtrate chamber, throughflow elements on one side and sealing elements on the other side and which are locked together by interlocking means. The draining spacing elements are designed for sealingly squeezing the filtering layers.

Due to the fact that the filtering layers lie flat on the draining spacing elements, the filtering layers being clamped between spacing elements in their marginal areas, and the fact that the draining spacing elements are interlocked by fastening means, there is provided an overall stable filter module, which cannot be distorted and which is thus capable of being flushed in the reverse direction. Deformation of the filtering layers during reverse flushing is effectively prevented.

Due to the fact that the draining spacing elements are disposed on both sides at the filtering layers and the filtering layers are thus supported on both sides, filtration may, if necessary, be carried out using filtering materials which exhibit low intrinsic rigidity.

The filtering action of these filter modules is exclusively defined by the properties of the filtering layers. This means that different filtering layers have to be used when it is desired to carry out multiple-stage filtration involving different filtering actions. Since the object to be achieved by filtration is determined by the filtering layers used, the overall height of the filter module will be correspondingly increased.

Another module, particularly a filter module, is disclosed in DE 100 65 258 A1. This filter module is intended to make it possible for the user to individually adapt the module to the desired object as regards the treatment of fluids whilst using the housing and connections of existing filtering contrivances without modification. This involves a filter module comprising cells, by which are meant all types of filter cell construction. These cells are not only used for filtration purposes, because the treating material that is introduced into the cells is not restricted to activated filtering materials but can comprise other substances, such as extractors. The stream of fluid flows radially both onto and through these filter cells.

Filter cells and filter modules containing such filter cells are disclosed, for example, in EP 0 233 999 A2 and DE 198 57 257 A1.

EP 0 233 999 A2 discloses a filter module in which the filter cells and supporting bodies are alternately stacked one above the other along a central pipe. In the filter cells there are also located supporting structures which support the filter medium in the filter cells. The non-filtrate is passed to the filter cells from outside and the filtrate is removed via the interior of the filter cells and through the central pipe.

Furthermore, so-called precoated filters are known in which filtration is carried out through activated filtering materials that have been introduced into the filter chambers. Such a filtering device is disclosed, for example, in EP 0 379 054 A2. In order to hold back the precoated material in the filter chambers, appropriate filter cloths are provided, which, however, are not intrinsically capable of performing any filtration task.

### SUMMARY OF THE INVENTION

It is an object of the invention to develop a filter module, particularly a filter module according to DE 100 29 960 A1, in such a manner that improved filtration is possible and a solid construction is given, whilst additional tasks relating to filtration and treatment of the fluid can be accomplished. Another object of the invention is to provide a process for the production of a filter module that is at least partially filled with treating material.

This object is achieved with a filter module wherein there is provided, at least between two filtering layers disposed between a first and a second spacing element, at least one third spacing element having sealing elements to seal off both the filtrate chamber and the non-filtrate chamber.

We have found, surprisingly, that a simple third spacing element forming a free space between the filtering layers and sealed against the filtrate chamber and the non-filtrate chamber provides, in a simple manner, improvement in filtration and increase in the scope of the filter module. During filtration, the fluid first of all passes through a filtering layer, spreads out in the free space, and then passes through another filtering layer. If several free spaces are provided, this process is repeated a corresponding number of times before the filtrate leaves the filter module. The choice of different filtering layers allows for the possibility of effecting, for example, prefiltration and postfiltration.

The free space between the layers of filtering material has an advantage over two directly superposed layers of filtering material in that the fluid in the free space can spread out so that there is complete flow-through thereof through the next filtering layer. In the case of directly superposed filtering layers, the flow path through the second filtering layer may possibly be dictated by the first filtering layer. If, for example, the first filtering layer has faulty areas, e.g., blocking regions, fluid will not flow through the corresponding regions of the superposed filtering layer. The free space guarantees that structural blemishes in the first filtering layer will not be propagated in the following filtering layer or layers. The free space is thus an outwardly closed space having a distributing function.

Furthermore, this free space can be used as a treatment chamber to accommodate at least one additional material for treating the fluid.

This third spacing element can be positioned at any desired point of the filter module between a first spacing element and a second spacing element and between two filtering layers. Third spacing elements can be provided both singly and, for certain filtration or treatment tasks, multiply with interposition of further filtering layers between a first and a second spacing element.

The thickness of the sealing elements for the third spacing element can be smaller than, equal to, or greater than the sealing elements or throughflow elements of the first and second spacing elements, by which means the volume of the free space can be adjusted.

If the free space only serves to provide better distribution of the fluid between two filtering layers, the thickness of the sealing elements can be smaller than the thickness of the throughflow or sealing elements for the first and second spacing elements.

If, on the other hand, charging of the free space with treating material is desired, it may be advantageous to provide a large free space which is capable of being filled. In this case, the thickness of the sealing elements for the third spacing element will be greater.

The free space formed by the third spacing element between two filtering layers is preferably at least partially filled with a material for treating the fluid.

More preferably, the free space is completely filled with the treating material.

Due to the fact that the fluid hits the filtering layers over their entire area at right angles to the plane of the layer, the fluid accordingly flows through the entire free space, which has the advantage that the total amount of treating material located in the treatment chamber is utilized. There are thus no dead spaces inside the treatment chamber, where fluid does not flow. Particularly when the fluid used is a liquid, regions might otherwise occur within the treatment chamber which differ in moisture content and might thus cause by-passes due to contraction of the treating material.

The treating material can be powdered, granular, fibrous and/or gel-like.

Suitable treating materials are preferably activated filtering materials. These include all known substances, such as pearlites, kieselguhr, fibrous materials, and also adsorbents such as activated carbon, PVPP, and iodated PVPP substances.

It has been found that the efficiency, for example, of activated carbon or PVPP is distinctly greater than, for example, in the case of layers of filtering material in which these treating materials have been embedded in the layer of filtering material during production, because the active surfaces are impaired by adhesion to the layer of filtering material. Thus the module of the invention requires less activated filtering material to provide a given performance and efficacy. This is, in particular, of great advantage in the case of expensive treating materials.

As regards the adsorbents, it is now possible to use sensitive materials, if desired. Thus adsorbents can be introduced into the free space(s) of the filter module which would otherwise become inactive during production of the filtering layers on account of the manufacturing process. The production of the filtering layers, particularly of beds of filtering material is based on an aqueous slurry which must be dried in an oven. In such a manufacturing operation water-sensitive or heat-sensitive adsorbents would become ineffective during production. Thus it is possible to open up completely new fields of application for such a module.

Suitable treating materials are, in addition, extractors, such as materials of vegetable origin which release active substances and in this manner impart the fluid to be treated with certain constituents or properties. An alternative possibility is to combine filtration with dosing of active substances, in which use can be made of preset porous components and dosing can take place via the treating material.

Due to the fact that the treatment chamber (free space) is closed, the filter module can be flushed back without washing out any treating material.

Preferably, the spacing elements possess fastening means which cooperate, e.g., interlock, when the module is assembled and in this way guarantee stable handling of the filter module even when a large number of filtering layers and spacing elements are present. All of the spacing elements or alternatively only one or two types of spacing elements may have fastening means. These fastening means are preferably designed such that the assembly of the filter module may be effected without the use of additional tools.

Preferably the fastening means are disposed on the outside of the spacing elements. The fastening means can cooperate to give a frictional or form-fitting lock.

In order to simplify the production of the spacing elements and to make it cheaper, the fastening means can form a single unit with the spacing element and thus be mounted or, if the spacing elements are made of, say, a plastics material, molded on during production.

Preferably, the fastening means form a clip-like joint.

The throughflow elements and the sealing elements have the fastening means preferably in the region of the filtrate chamber or the non-filtrate chamber.

The treating material can be introduced into the free space(s) when the filter module is being assembled or, alternatively, after it has been assembled. In all cases at least the initial introduction of treating material will be carried out prior to filtration of the fluid.

In the first case the treating material will be introduced when a third spacing element is inserted.

In the second case, the filter module will be provided with at least one filling conduit for the treating material, which filling conduit is not identical with the throughflow channel provided in the first and second spacing elements for the fluid to be treated.

Filling or charging of the filter module can thus be carried out by the user, who can introduce the treating material into the free space(s) before or after installation of the module in a filter housing of a filter device. When the empty filter module is placed in the filter housing, introduction of the treating material can take place with the cover of the housing open so that the filter module is accessible from above. The housing generally is equipped with a connecting element providing fluid communication from the exterior with the filtrate chamber and a connecting element providing fluid communication with the non-filtrate (feed) chamber.

Alternatively a so-called in-line filling can be carried out, i.e., filling is carried out, with said cover of the housing closed, through appropriate additional connecting element(s) on the filter housing. Such additional connecting element(s) preferably provide a fluid communication from the exterior with the filling channel and the free spaces.

In the case of in-line filling, it is possible to provide for constant replenishment of treating material at intervals during filtration. To this end, it is advantageous to place the filling conduit(s) in a position making it possible for the treating material to completely flow through the free spaces when effecting a change of material. The free spaces can be connected to each other via filling conduits in an arbitrary order and in arbitrary manner, this being dependent on the particular application.

The provision of an additional connecting element for establishing a fluid communication from the exterior of the filter housing with the filling conduit and consequently with the free space(s) provides for several additional advantages. Not only can the free space(s) be charged, discharged and recharged while the housing remains closed and sealed off but also filling of the free space(s) can be completed during operation of the filter module. This is of importance, when, as is often observed with particulate treating material, the treating material upon becoming wet and consequently more compacted resulting in voids occupied by treating material which can result in non-uniform treatment of the filtered fluid.

In addition, the users of the filter devices are able to charge the free spaces in the filter modules, as required, with treating materials actually required without the need for keeping various filter devices filled with different treating material in stock. Furthermore, the filter device may be in-line sterilized after charging with treating material.

A further advantage resides in the possibility of flushing, regenerating or back-flushing the filter module in different ways without causing blockage of end filter layers.

In order to form a filling conduit, each of the spacing elements preferably are provided with at least one channel element. The arrangement of the channel elements can be the same for all spacing elements so that when the filter module has been assembled the channel elements are disposed one above the other. Alternatively, the sections of the filling conduit connecting two free spaces can be in staggered relationship to each other.

The channel element preferably has at least one throughflow channel. This throughflow channel preferably is at right angles to the plane of the spacing element and thus extends parallel to the longitudinal axis of the filter module.

The channel element of the third spacing element preferably has, per throughflow channel, at least one distributing channel, which opens into the throughflow channel at one end, and into the free space formed by the spacing element at the other end. The third spacing element can additionally have at least one channel element exhibiting only one or more throughflow channels, if the free spaces are to be filled with different treating materials. In this case the relevant treating material is merely passed on and fed to another free space or other free spaces. Alternatively, individual third spacing elements can have exclusively channel elements having no distributing channels if the relevant free space is not to be filled.

The channel elements can be single parts designed to fit into corresponding holes in the spacing elements. Each channel element can, for example, have only one throughflow channel.

This has the advantage that the arrangement of the channel elements in the spacing elements can be flexibly handled.

An alternative possibility is to provide the channel elements with several throughflow channels. Such a channel element can be an annular element which is inserted into a spacing element.

Finally it is also conceivable to form the channel elements as a single unit with the spacing element. The channel elements are in this case produced during production of the spacing elements.

In order to provide one or more filling conduits in the filter module, the filtering layers must be provided with one or more holes at positions where the spacing elements exhibit their throughflow channels. The cross-section of the holes is preferably equal to the diameter of the throughflow channels.

To prevent the formation of by-passes in the region of the throughflow channels, the channel element is, at least in the region of the throughflow channel and at least on one side, thicker than the spacing fins of the spacing element.

The channel element preferably has the same thickness as the sealing element or the throughflow element of the associated spacing element. The result of this measure is that when the filter module is assembled the filtering layer is pressed together in the region of the channel elements in the same way as is the case in the region of the sealing elements or throughflow elements.

In a process of the present invention for the production of a filter module that is at least partially filled with treating material the treating material is introduced when each first, second, and third spacing element and the associated filtering layer(s) are assembled. The treating material is in this case always introduced when a third spacing element has been added.

According to another variant of the inventive process, the treating material is introduced through the filling conduit(s) following the assembly of the filter module.

The treating material can be introduced after the filter module has been placed in the filter housing of the filter device. This requires corresponding connections on the filter housing.

The treating material is preferably introduced prior to commencement of filtration.

Alternatively, provision may be made for replacement and renewal of the treating material during filtration, and it is also possible to effect a continuous flow of treating material through the free spaces.

Exemplary embodiments of the invention are illustrated in greater detail below.

### BRIEF DESCRIPTION OF THE DRAWINGS

In the drawings:

FIG. 1 is a vertical cross section through a filter module;

FIG. 2 is an enlarged section of the filter module shown in FIG. 1;

FIG. 3a is a vertical cross section through a filter module corresponding to FIG. 1 and containing treating material;

FIG. 3b is a vertical cross section through a filter module according to another embodiment;

FIG. 4a is a vertical cross section through a filter module according to another embodiment having a separate filling conduit;

FIG. 4b is the vertical cross section of FIG. 4a, the filter module being placed in a housing of a filter device having an additional connector element for accessing the filling conduit;

FIG. 5a is a top view of a third spacer;

FIG. 5b is a top view of a first spacer;

FIGS. 6a, 6b are top views of spacers according to further embodiments;

FIG. 7 is a vertical cross section through a filter module according to another embodiment, and

FIG. 8 is a vertical cross section through a filter module according to another embodiment.

### DETAILED DESCRIPTION OF THE INVENTION

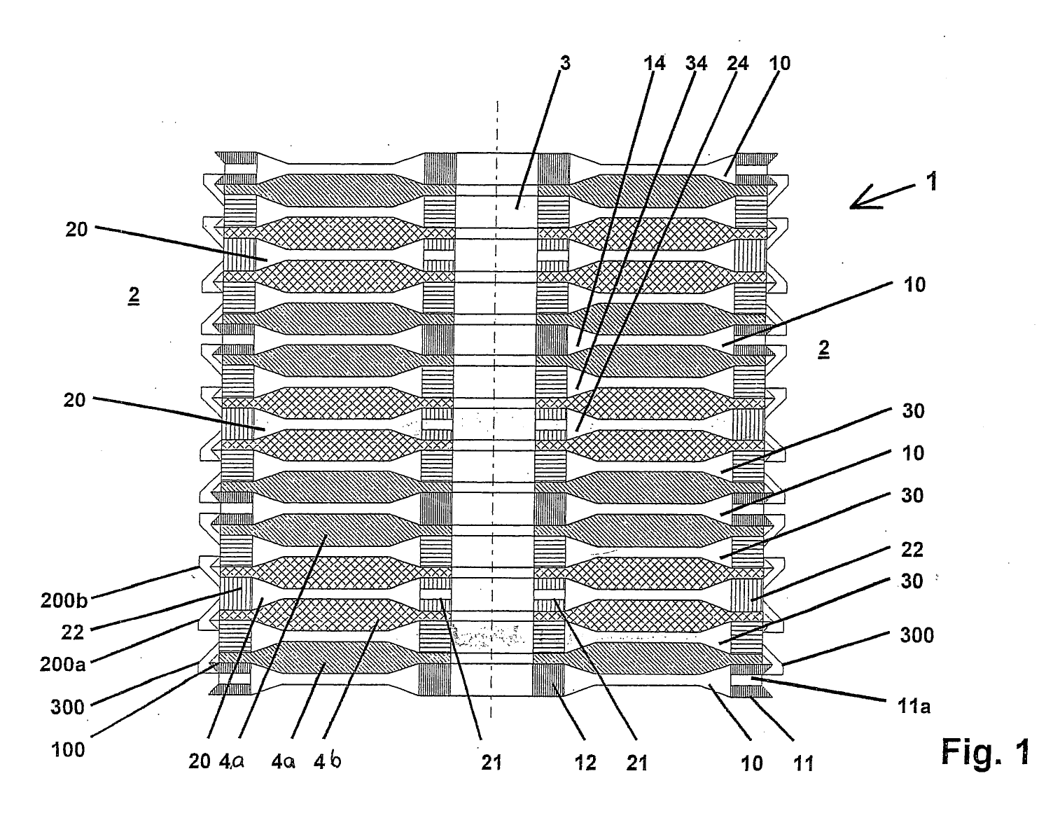

FIG. 1 illustrates a filter module 1 in vertical cross section. This filter module 1 is composed of a plurality of first spacers 10, second spacers 20, third spacers 30 and interposed filtering layers 4, 4a, and 4b. The spacers 10, 20, and 30 are designated by different hatch patterns, although they may be of the same material. The three spacing elements differ from each other substantially in the arrangement of their throughflow elements 11 and 21 and sealing elements 12, 22, 31, and 32.

The filtering layers 4, 4a, and 4b exhibit different filtration properties.

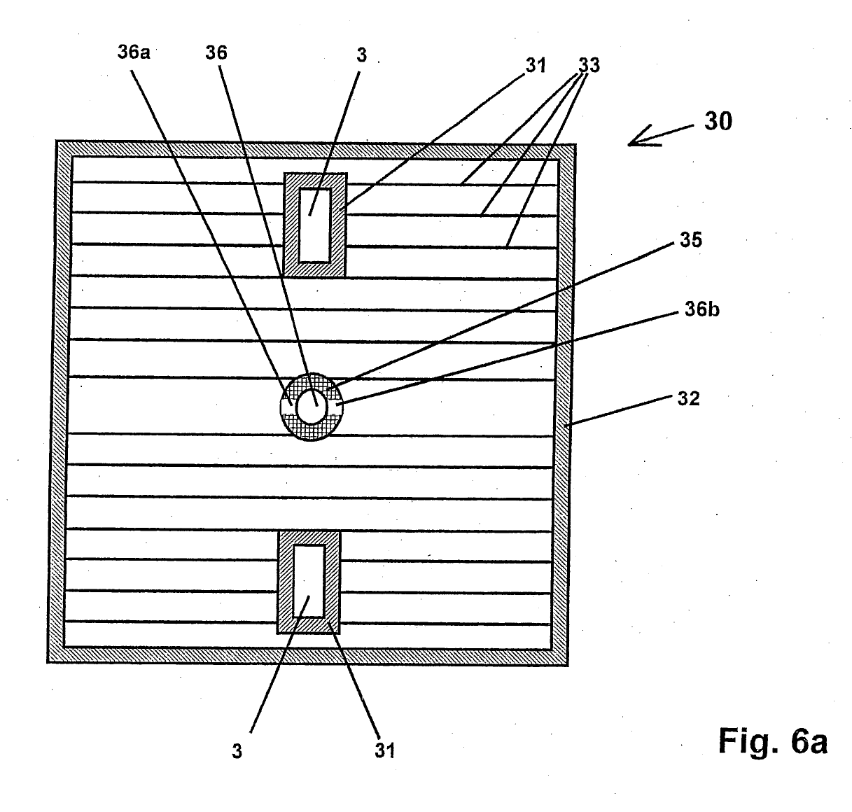

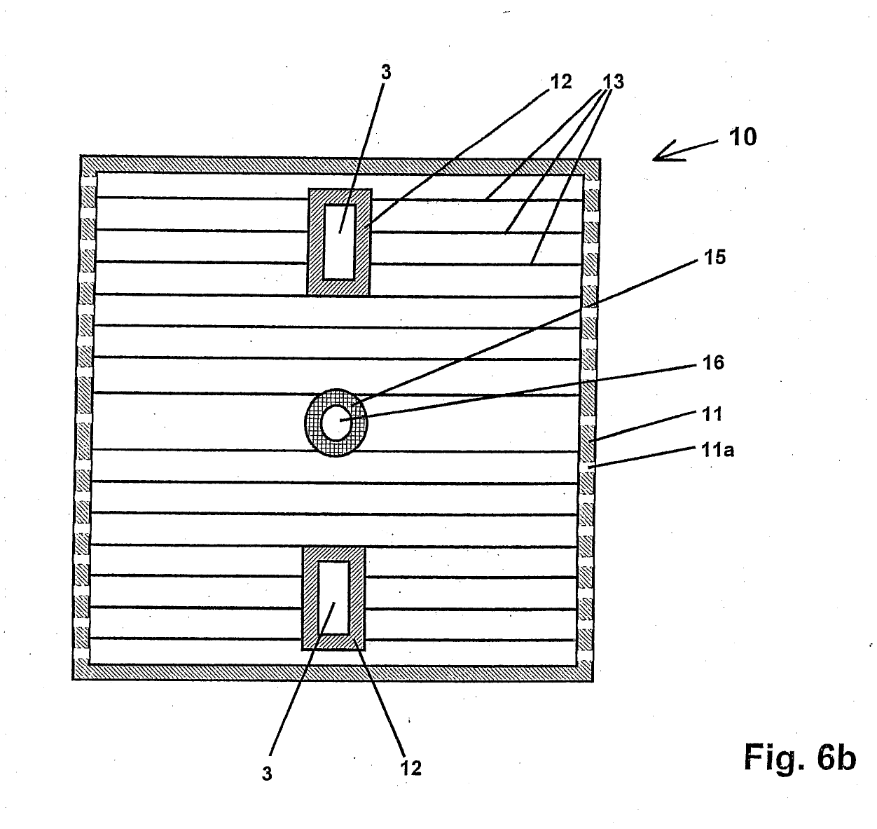

In the embodiment shown here, the spacing elements 10, 20, and 30 and the filtering layers 4, 4a, and 4b are circular. Other shapes are equally possibly, such as a square shape (see also FIGS. 6a and 6b).

This filter module 1 possesses at the center an outflow channel, which forms the outflow or filtrate chamber 3. In this case, the fluid to be filtered enters the filter module from outside, so that the surrounding space forms the inflow or non-filtrate chamber 2. Reversed inflow via filtrate chamber 3 is likewise possible. In this case the on-centre channel forms the non-filtrate chamber, and the environment of the filter module forms the filtrate chamber.

Between the individual spacing elements 10, 20 and 30 there are disposed filtering layers 4, 4a, and 4b, particularly beds of filtering material. These beds of filtering material are appropriately perforated in the region of the filtrate channel 3 and are contacted and squeezed by the spacing elements 10, 20, and 30 both in the marginal area of the outflow channel and at their perimeters. The establishing of contact and squeezing of the filtering material at those edges provides a sufficiently tight seal at the edges of the filtering layers.

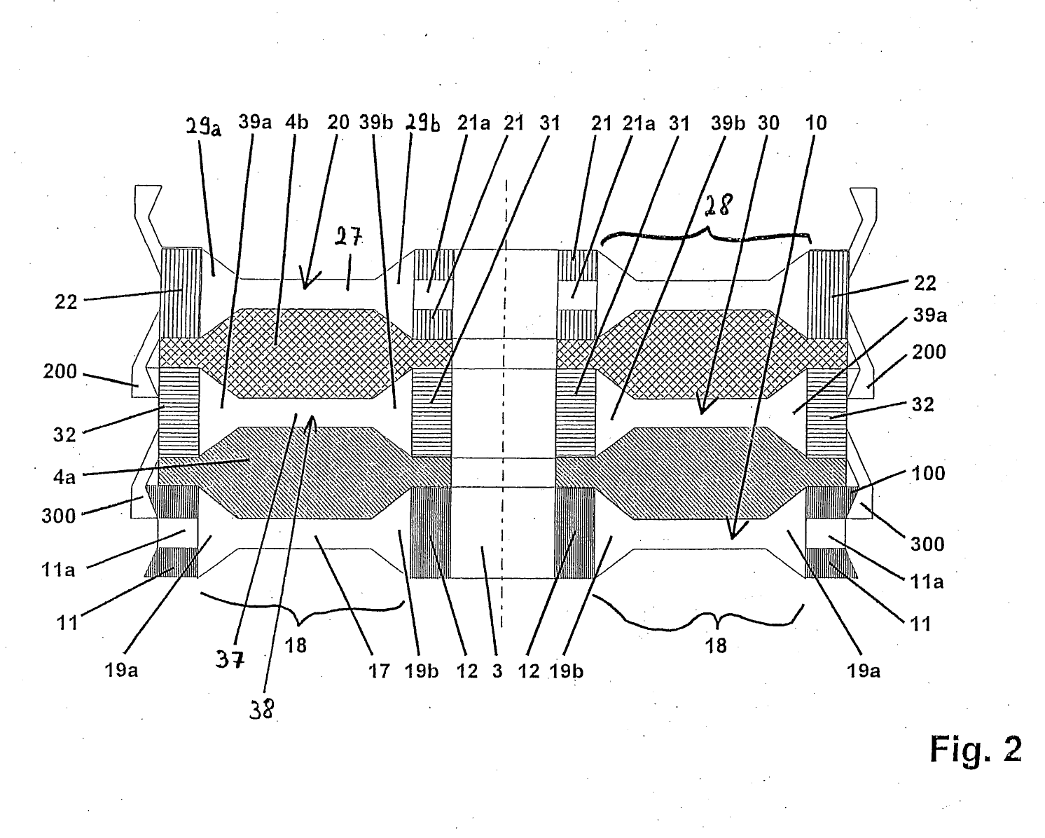

The first spacing element 10 possesses at its perimeter an annular throughflow element 11, which exhibits one or more throughflow channels 11a and thus provides access from the non-filtrate chamber 2. This is adjoined radially inwardly by an annular draining element 18 (cf FIG. 2), which exhibits a large number of spacing fins 17, set at intervals. The draining element is, for example, a perforated plate on which the spacing fins 17 are in the form of a texture of the plate. In the embodiment shown here, these spacing fins can exhibit tapered connecting means 19a, 19b on both sides. The spacing fins 17 and the connecting means 19a, 19b together form the draining element 18 in this case.

Radially inwardly thereof, said element is adjoined by an annular sealing element 12. The thicknesses of throughflow element 11 and sealing element 12 are the same.

Between the filtering layers 4a and 4b there is formed, by draining element 18, a free space, which is herein referred to as the first space 14. The non-filtrate flows in through the throughflow channel 11a into this first space 14 and then flows through the adjacent filtering layers 4a, 4b, by which means filtration takes place.

A second spacing element 20 is basically of the same design, the arrangement of the sealing element 22 and the throughflow element 21 with its throughflow channel 21 a being interchanged compared with the first spacing element 10. This means that sealing element 22 is disposed adjacent the non-filtrate chamber 2 and throughflow element 21 is disposed adjacent the filtrate chamber 3. The second spacing element 20 also possesses an annular draining element 28 comprising spacing fins 27 and connecting means 29a, b.

The second space 24 formed between the filtering layers 4a and 4b thus forms a filtrate chamber, in which the fluid that has been filtered by the filtering layers 4, 4a, and 4b collects and flows out, as filtrate, into the filtrate chamber 3.

The third draining and spacing element 30 likewise possesses a draining element 38 comprising spacing fins 37 and connecting means 39a and 39b, and also only sealing elements 31 and 32 so that between these sealing elements and the adjacent filtering layers 4, 4a, and 4b there is formed a treatment chamber 34, which is closed on all sides. The details of the individual elements are shown in greater detail in FIG. 2.

FIG. 2 also shows the fastening means 100, 200, and 300, which are formed, in the present working example, by snap lugs and catches disposed outside the sealing elements or throughflow elements 11, 12, 21, 22, 31, and 32. When assembling a filter module, the connecting means snap together so that the individual spacing elements can, together with the filtering layers, be readily put together without the use of tools.

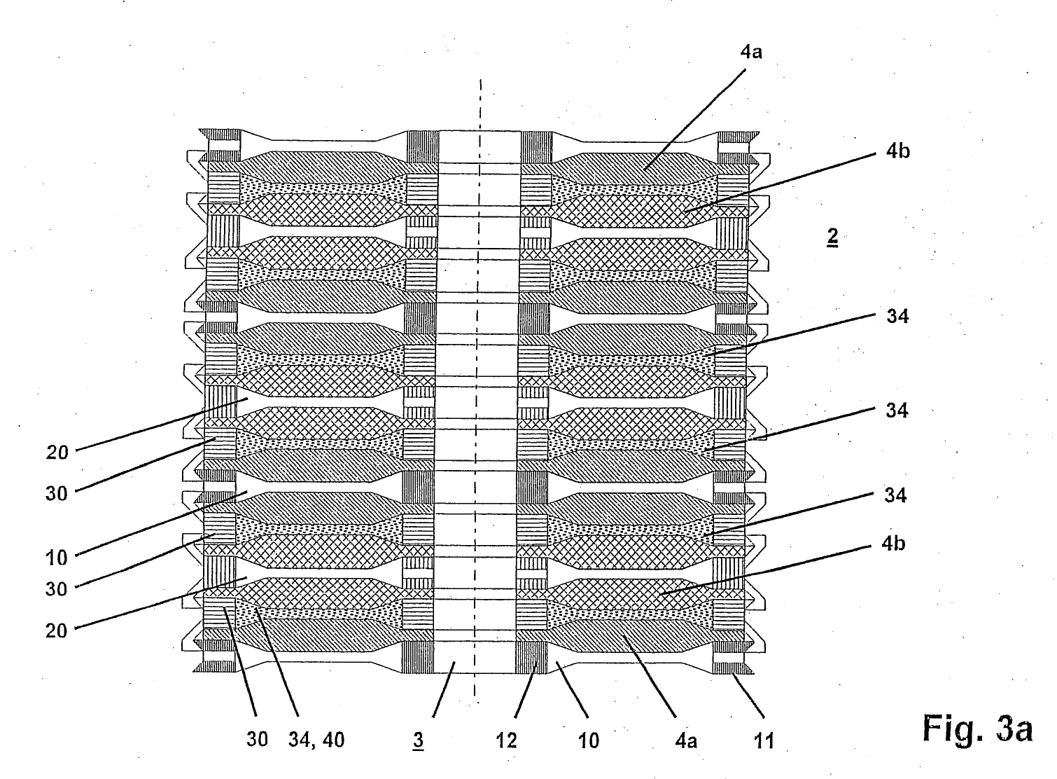

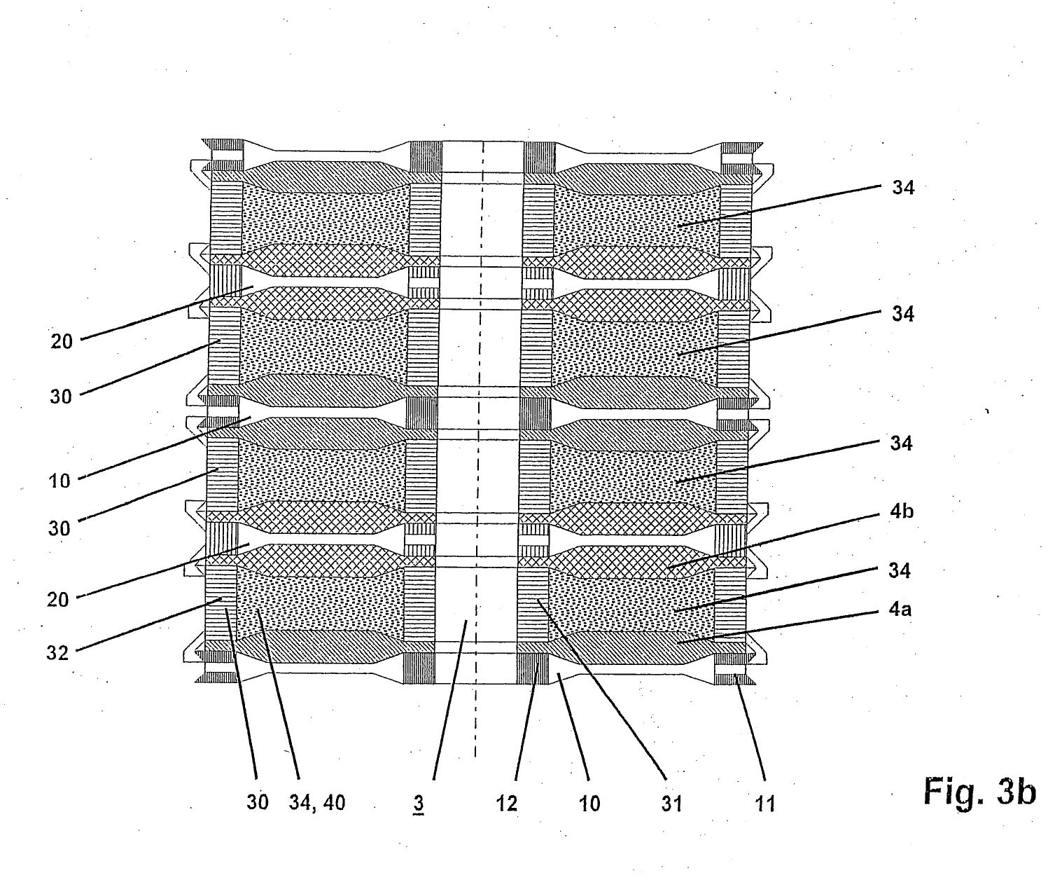

FIG. 3 illustrates a filter module in vertical cross section, which module is the same as that shown in FIG. 1, treating material 40 having been placed in treatment chamber 34. In this embodiment, the treating material 40 was introduced during assembly of the filter module.

FIG. 3b is a vertical cross section, which clearly shows that the third spacing elements 30 are significantly thicker than the other spacing elements 10 and 20. Varying the thickness of the third spacing element 30 adjusts the capacity of the treatment chamber 34.

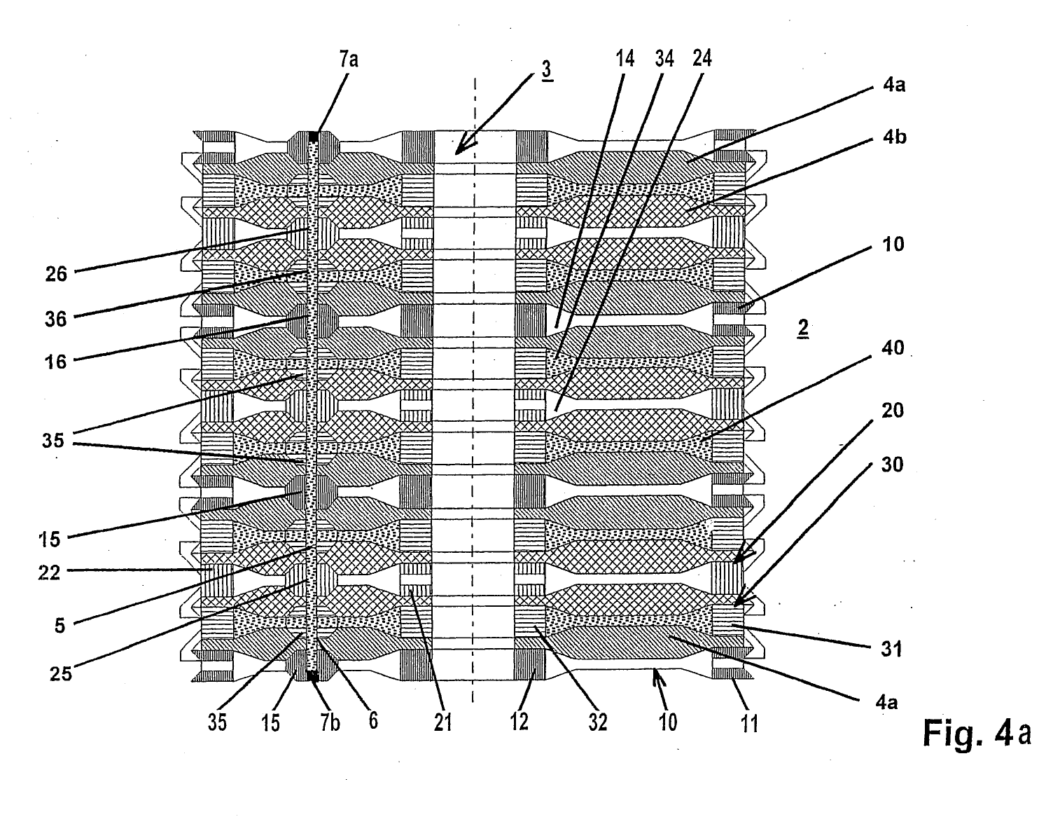

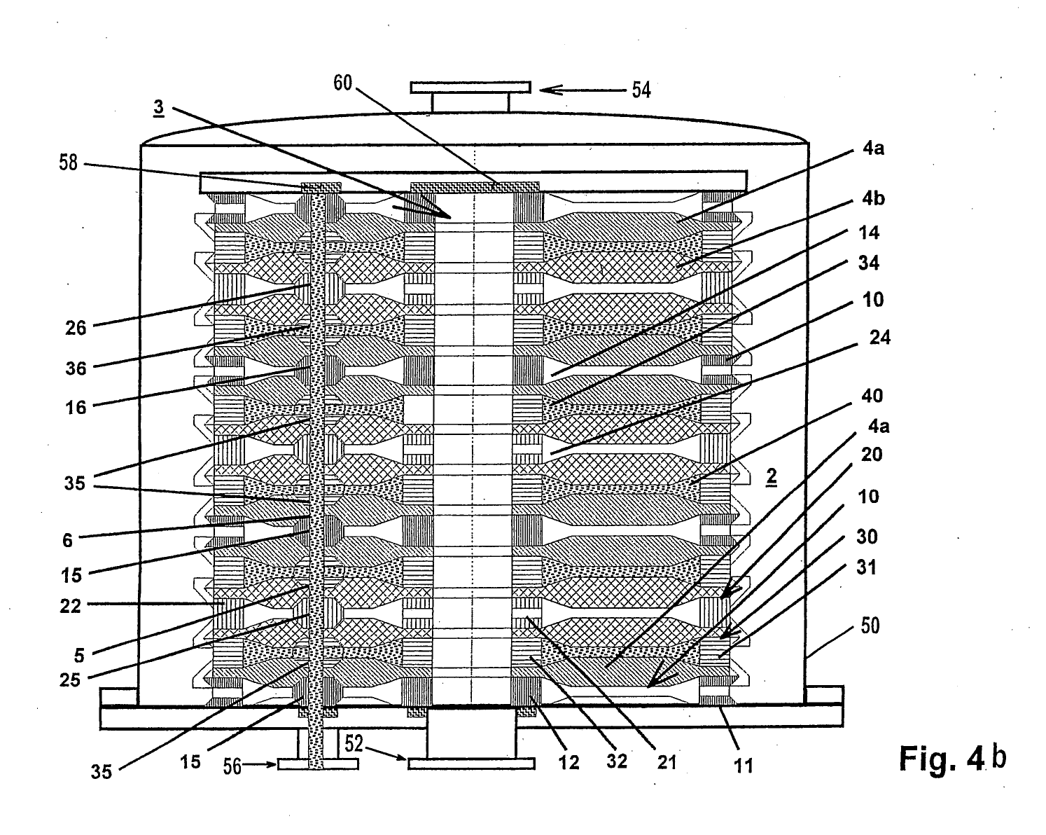

FIG. 4a illustrates another embodiment, in which filter module 1 exhibits at least one filling conduit 6 which extends parallel to the long axis of the filter module and is thus parallel to the outflow channel 3. The filling conduit 6 is disposed, in the embodiment shown here, in the region of the draining elements 18, 28 and 38. The position of the filling conduit(s) 6 is arbitrary. However a position is preferably selected such as has access to equally large regions of the treatment chamber, as this facilitates filling.

In order to make a filling conduit 6, the spacing elements 10, 20, and 30 each exhibit channel elements 15, 25, and 35, which are disposed one over the other in the assembled filter module. The top and bottom channel elements can both be sealed by a closing element 7a and 7b when filling is finished.

The spacing elements 10 and 20 possess channel elements 15, 25 each having only one throughflow channel 16, 26. In the embodiment shown here, the channel elements 35 of the third spacing element 30 possess, in addition to the throughflow channel 36, two distributing channels 36a and 36b branching off from the throughflow channel 36 and thus allowing access to the free space or to treatment chamber 34.

The axial thickness of the channel elements 15, 25, and 35 is equal to the thickness of the sealing elements or throughflow elements 11, 12, 21, 22, 31, and 32 so that in these regions the filtering layers 4, 4a, and 4b are squeezed in the same way as in the region of the throughflow elements and sealing elements. In this region each filtering layer 4, 4a and 4b possesses a perforation 5, whose cross-section is equal to the diameter of the throughflow channels 16, 26, and 36.

FIG. 4b shows the filter module of FIG. 4a included in a filter housing 50 of a filter device. The housing 50 is provided with connection elements 52 and 54, providing a fluid communication with the filtrate chamber 3 and the non-filtrate or feed chamber 2, respectively. Additionally the housing 50 is provided with an additional connecting element 56 establishing a fluid communication with the filling conduit 6.

The filling conduit 6 is sealed off on top of the filter module 1 by sealing element 58. The filtrate chamber 3 is closed at its upper end by a cover lid 60. Sealing element 58 and cover lid 60 prevent fluid communication between the filling conduit 6 and the feed chamber 2 and the filtrate chamber 3 and the feed chamber 2, respectively.

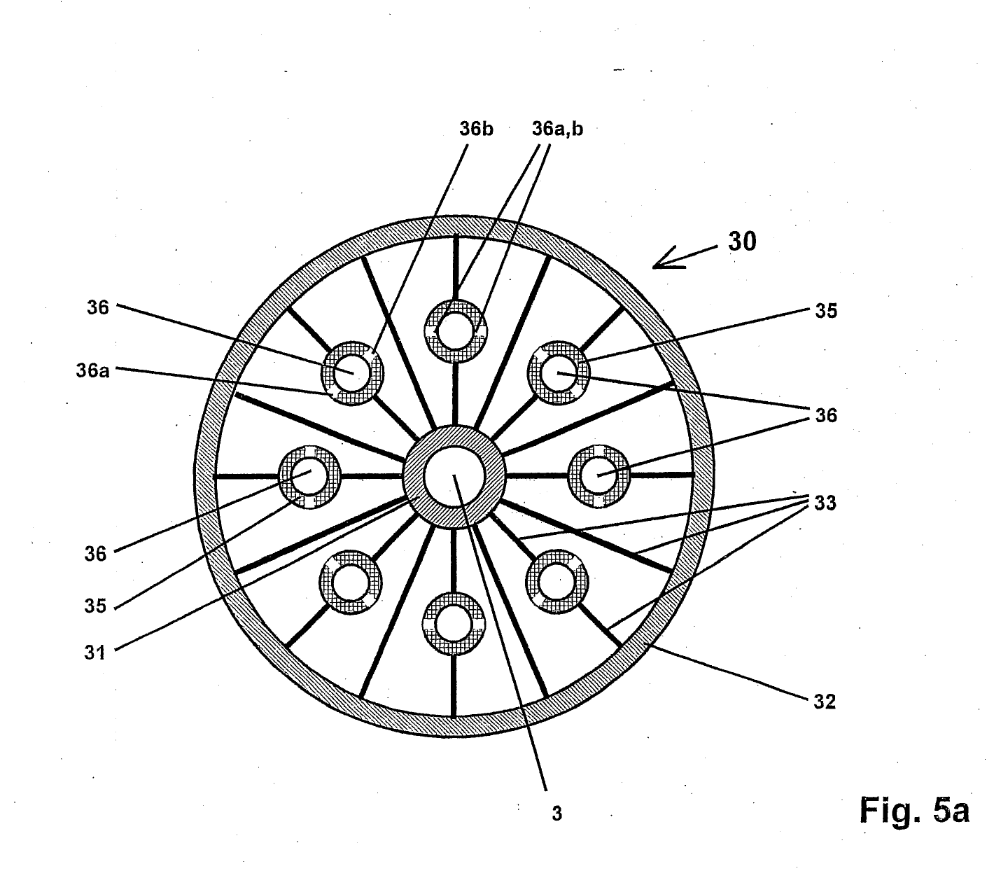

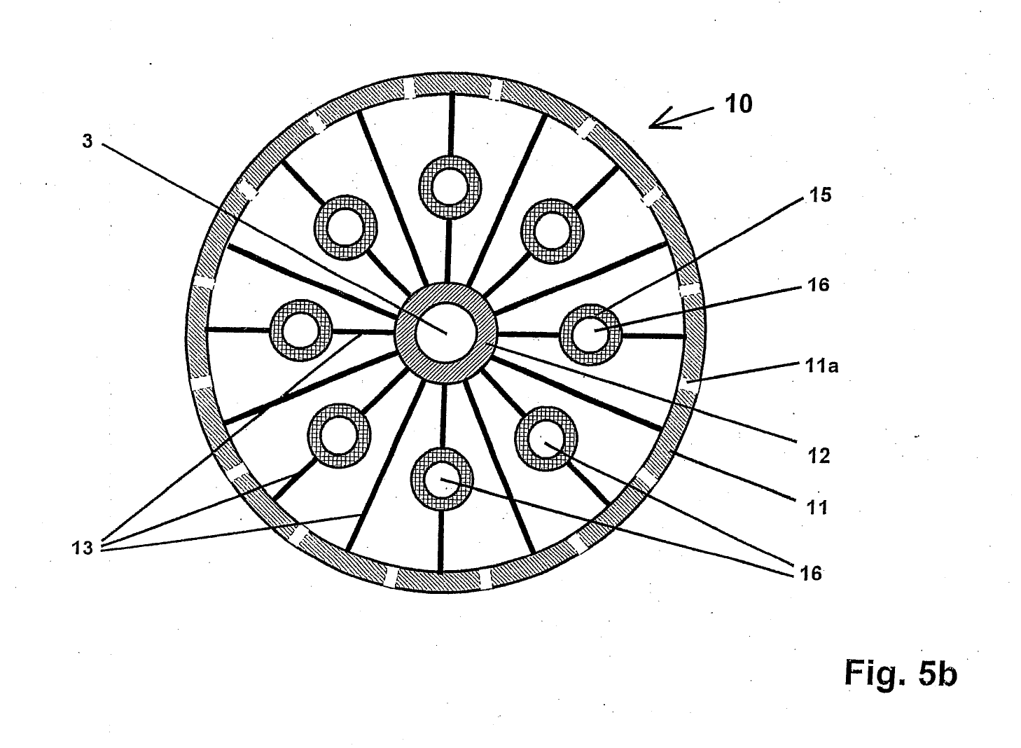

FIG. 5a is a plan view of a third spacing element 30 according to another embodiment. This third spacing element 30 has a spoked design and possesses an inner sealing element 31 and an outer sealing element 32, between which spacing fins 33 extend radially in the form of spokes. These spacing fins 33 serve as spacers for the adjacent filtering layers 4, 4a, and 4b, and between the fins there is a free space, which can be used as a treatment chamber 34. Furthermore, this spacing element exhibits a central ring, which has several throughflow channels 36 and thus forms the channel element. On each side of the throughflow channels 36, distributing channels 36a and 36b, branch off to provide access to the treatment chamber 34.

FIG. 5b illustrates a first spacing element 10 having a sealing element 12 at the inner perimeter and a throughflow element 11 with its radially disposed throughflow channels 11a, at the outer perimeter. This spacing element 10 also possesses radial spacing fins 17 and an annular channel element 15 with throughflow channels 16. A second spacing element 20 is not separately illustrated, since it is basically the same as first spacing element 10 except for the fact that the sealing elements and throughflow elements are interchanged.

FIG. 6a illustrates a third spacing element 30 having a square peripherie. Accordingly, the external sealing element 32 is a square frame, within which spacing fins 33 extend in parallel. In the center there is a throughflow channel 36 with its channel element 35, in which two opposite distributing channels 36a and 36b are disposed. This third spacing element 30 is provided for a filter module exhibiting two outflow channels 3, each of which is bounded by a rectangular inner sealing element 31. A corresponding first spacing element 10 is shown in FIG. 6b. The throughflow channels 11a are located in the two opposite regions of the outer throughflow element 11. The corresponding second throughflow elements 20 are likewise square-shaped. This also applies to the filtering layers.

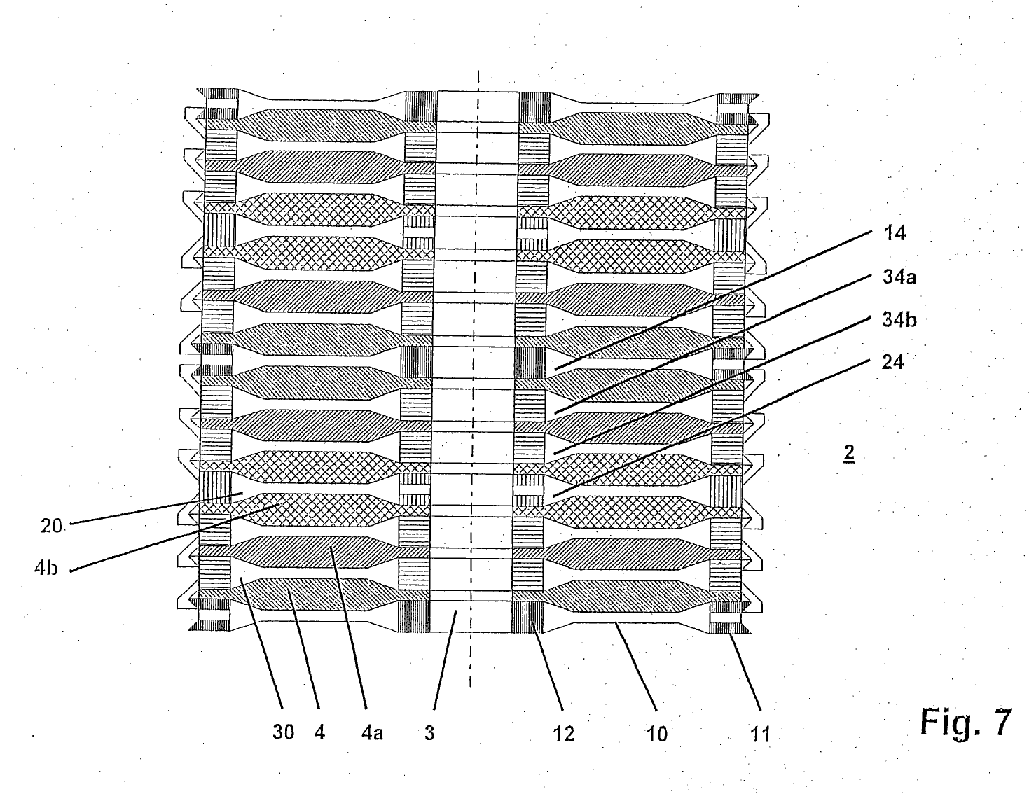

FIG. 7 illustrates another embodiment of a filter module 1. This filter module differs from the filter module according to FIG. 1 in that between a first spacing element 10 and a second spacing element 20 there are disposed two third spacing elements 30, and between the two third spacing elements 30 there is disposed a filtering layer 4. The filtering layers 4 may exhibit different filtering characteristics, if desired. Similarly, the two treatment chambers 34a and 34b may contain different materials. Thus two superposed treatment chambers are created which may be filled with treating materials 40.

This example shows that any desired arrangement of spacing elements 10, 20, and 30 is possible so that the filter module can be made up so as to fulfil the aims of filtration and treatment as required.

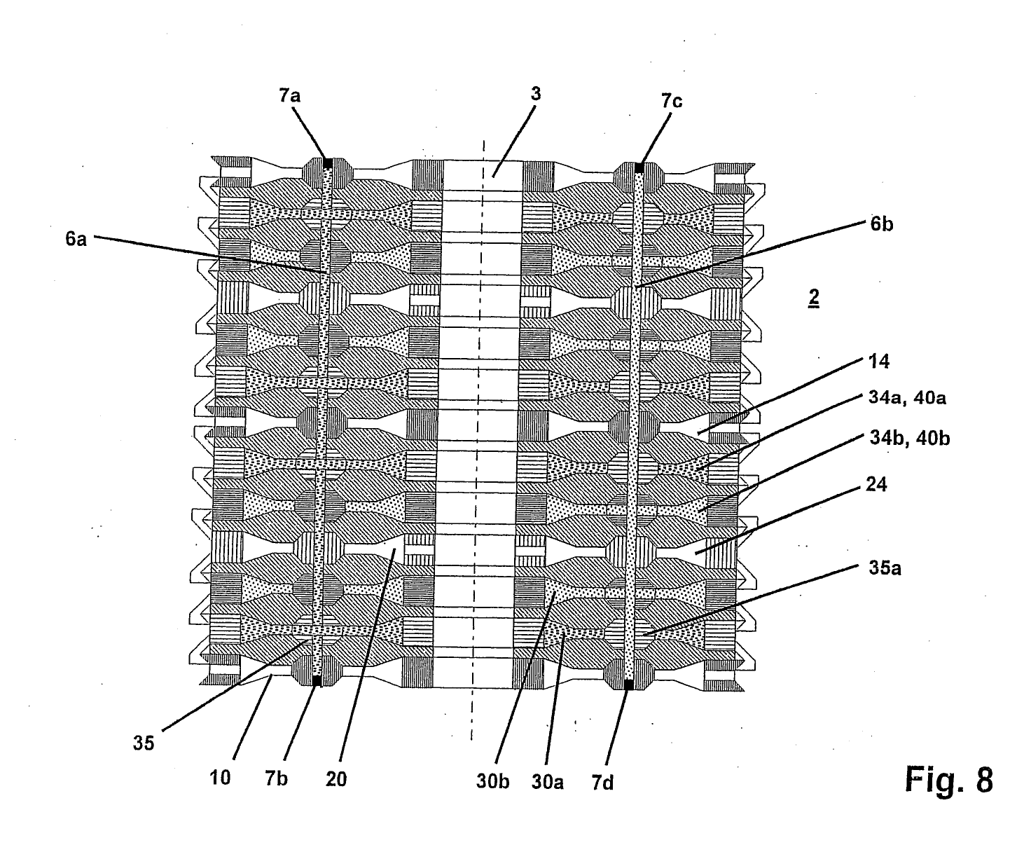

FIG. 8 is a vertical cross section through a filter module containing different treating materials in the two treatment chambers 34a and 34b, which can be filled via appropriate filling conduits 6a and 6b after the filter module has been assembled.

In order to achieve this, the third spacing elements 30 are equipped with channel elements 35, which have a throughflow channel 35 and also one or more distributing channels 36a and 36b. Furthermore, these third spacing elements 30 possess channel elements 35a having only one throughflow channel. The filling conduits 6a and 6b are on engagement by the closing elements 7a and 7c. In the lower first spacing element 10 there are located closing elements 7b and 7d. The field of application is additionally broadened by this embodiment.

1. A filter module comprising filtering layers comprising a filtering medium, said filtering layers being arranged alternatingly with layers of first and second spacing elements, the draining spacing elements each having, in alternating sequence with respect to a filtrate chamber and a non-filtrate chamber, a throughflow element on one side and a sealing element on the other side, wherein the spacing elements are designed to sealingly contact and squeeze the filtering layers, and wherein at least between two of said filtering layers disposed between a first and a second spacing element, at least one third spacing element having sealing elements to seal off both the filtrate chamber and the non-filtrate chamber is provided.

2. The filter module as defined in claim 1, wherein the sealing elements of the third spacing element have a thickness that is greater than the thickness of the throughflow element or sealing element of the first or second spacing element.

3. The filter module as defined in claim 1, wherein a free space formed by the third spacing element between two filtering layers is at least partially filled with a material for treating the fluid.

4. The filter module as defined in claim 1, having an interior containing dry treating material.

5. The filter module as defined in claim 1, containing a treating material wherein the treating material is powdered, granular, fibrous and/or gel-like.

6. The filter module as defined in claim 1, wherein at least some of the spacing elements have, in the region of at least one filtrate chamber or non-filtrate chamber, fastening means, which fastening means of said spacing elements cooperate with the fastening means of at least one other spacing element.

7. The filter module as defined in claim 6, wherein the fastening means are disposed on the outside of the spacing elements.

8. The filter module as defined in claim 6, wherein the fastening means cooperate by friction or form-fit.

9. The filter module as defined in claim 6, wherein the fastening means form a single unit with the spacing element.

10. The filter module as defined in claim 6, wherein the fastening means form a clip-like connection.

11. The filter module as defined in claim 6, wherein the throughflow elements and sealing elements in the region of the filtrate chamber or non-filtrate chamber comprise said fastening means.

12. The filter module as defined in claim 1, wherein the module comprises at least one filling conduit for the treating material, which is not identical with the throughflow channel for the fluid to be treated.

13. The filter module as defined in claim 1, wherein each of the spacing elements has at least one channel element.

14. The filter module as defined in claim 13, wherein the channel element comprises at least one throughflow channel.

15. The filter module as defined in claim 12, wherein the channel element of the third spacing element comprises at least one distributing channel per throughflow channel, which distributing channel opens into the throughflow channel and into the treatment chamber formed by the spacing element.

16. The filter module as defined in claim 13, wherein the third spacing element comprises at least one channel element and at least one channel element having only one or more throughflow channels.

17. The filter module as defined in claim 13, wherein the spacing element has spacing fins and the channel element is, at least in the region of the throughflow channel, thicker, on at least one side, than the spacing fins of the spacing element.

18. The filter module as defined in claim 13, wherein the channel element has essentially the same thickness as the sealing element or throughflow element.

19. A filter device comprising a filter housing defining with its walls a chamber accommodating a filter module according to claim 1, wherein said housing comprises connecting elements which provide fluid communication through a wall of the housing with said filtrate chamber and non-filtrate chamber, respectively.

20. The filter device of claim 19, wherein the filter housing comprises an additional connecting element providing fluid communication through a wall of the housing with said filling conduit.

21. A process for the production of a filter module as defined in claim 1 which is at least partially filled with treating material, comprising introducing the treating material during assembly of each first, second, and third spacing element and the associated filtering layer(s).

22. A process for the production of a filter module as defined in claim 1 which is at least partially filled with treating material, comprising introducing the treating material through one or more filling conduit(s) following the assembly of the filter module.

23. A process as defined in claim 22, wherein the treating material is introduced after the filter module has been placed in the filter housing.

24. The process as defined in claim 22, wherein the treating material is introduced prior to commencement of filtration.

25. The process as defined in claim 23, wherein the treating material is replaced during filtration.

26. The filter module of claim 6, wherein the third spacing element comprises fastening means, which cooperate with the fastening means of the first and/or second spacing element.
